(19) United States
(12) Patent Application Publication
(10) Pub. No.: US 2026/0030545 A1
(43) Pub. Date: Jan. 29, 2026

(54) USING SYNTHETIC DATA TO SUPPLEMENT SMALL DATASETS

(71) Applicant: Capital One Services, LLC, McLean, VA (US)

(72) Inventors: Niharendu CHANDRA, Glen Allen, VA (US); Sunilkumar KRISHNAMOORTHY, Glen Allen, VA (US)

(21) Appl. No.: 18/785,490

(22) Filed: Jul. 26, 2024

(51) Int. Cl. G06N 20/00

(52) U.S. Cl. CPC G06N 20/00

(57) ABSTRACT

In some implementations, a model organizer may receive, from a data source, the original dataset. The model organizer may receive, from an administrator device, an indication of a first factor to remain fixed and an indication of at least one second factor to refrain from anonymizing. The model organizer may provide the original dataset to a synthetic generation model in order to receive the synthetic dataset. The synthetic generation model may refrain from varying the first factor and may anonymize at least one third factor. The model organizer may receive, from the administrator device, an indication of an underwriting model. The model organizer may provide the original dataset and the synthetic dataset to the underwriting model for training, testing, or refinement. The model organizer may transmit, to the administrator device, a notification that the underwriting model has been trained, tested, or refined.

### BACKGROUND

Training and using a machine learning model (e.g., an underwriting model, among other examples) is usually performed with a large dataset. If the machine learning model is trained on a smaller dataset, the machine learning model may suffer from overfitting and other inaccuracies. Therefore, the power and processing resources consumed in training the machine learning model are used inefficiently (or even wasted if the machine learning model is too inaccurate to use).

### SUMMARY

Some implementations described herein relate to a system for generating a synthetic dataset to supplement an original dataset. The system may include one or more memories and one or more processors communicatively coupled to the one or more memories. The one or more processors may be configured to receive, from a data source, the original dataset. The one or more processors may be configured to receive, from an administrator device, an indication of a first factor to remain fixed. The one or more processors may be configured to receive, from the administrator device, an indication of at least one second factor to refrain from anonymizing. The one or more processors may be configured to provide the original dataset to a synthetic generation model in order to receive the synthetic dataset, wherein the synthetic generation model refrains from varying the first factor and anonymizes at least one third factor. The one or more processors may be configured to receive, from the administrator device, an indication of an underwriting model. The one or more processors may be configured to provide the original dataset and the synthetic dataset to the underwriting model for training. The one or more processors may be configured to transmit, to the administrator device, a notification that the underwriting model has been trained.

Some implementations described herein relate to a method of generating a synthetic dataset to supplement an original dataset. The method may include receiving, at a model organizer and from a data source, the original dataset. The method may include receiving, at the model organizer and from an administrator device, an indication of a first factor to remain fixed. The method may include receiving, at the model organizer and from the administrator device, an indication of at least one second factor to refrain from anonymizing. The method may include providing the original dataset to a synthetic generation model in order to receive the synthetic dataset, wherein the synthetic generation model refrains from varying the first factor and anonymizes at least one third factor. The method may include receiving, at the model organizer and from the administrator device, an indication of an underwriting model. The method may include providing the original dataset and the synthetic dataset to the underwriting model for testing or refinement. The method may include transmitting, from the model organizer and to the administrator device, a notification that the underwriting model has been tested or refined.

Some implementations described herein relate to a non-transitory computer-readable medium that stores a set of instructions for requesting a synthetic dataset to supplement an original dataset. The set of instructions, when executed by one or more processors of a device, may cause the device to transmit, to a model organizer, an indication of the original dataset. The set of instructions, when executed by one or more processors of the device, may cause the device to transmit, to the model organizer, an indication of a first factor to remain fixed. The set of instructions, when executed by one or more processors of the device, may cause the device to transmit, to the model organizer, an indication of at least one second factor to refrain from anonymizing. The set of instructions, when executed by one or more processors of the device, may cause the device to receive, from the model organizer, a notification that the synthetic dataset has been generated by a synthetic generation model, wherein the synthetic generation model refrains from varying the first factor and anonymizes at least one third factor.

### BRIEF DESCRIPTION OF THE DRAWINGS

FIGS. 1A-1D are diagrams of an example implementation relating to using synthetic data to supplement small datasets, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIGS. 4-5 are flowcharts of example processes relating to using synthetic data to supplement small datasets, in accordance with some embodiments of the present disclosure.

### DETAILED DESCRIPTION

The following detailed description of example implementations refers to the accompanying drawings. The same reference numbers in different drawings may identify the same or similar elements.

Generally, a large dataset is used to train a machine learning model (e.g., an underwriting model, among other examples). If a smaller dataset is used, overfitting and other inaccuracies may affect the machine learning model. As a result, computer resources expended in training the machine learning model were used inefficiently. Indeed, if the machine learning model is too inaccurate, an administrator may determine that the machine learning model is unusable, which means the computer resources expended in training the machine learning model were wasted.

After training, a machine learning model may be improved with testing and/or refinement. For example, additional data may be collected (e.g., from labeling new data and/or from feedback based on output from the machine learning model) and used to test and/or refine the machine learning model. However, if a smaller dataset is used for testing and/or refinement, inaccuracies may again affect the machine learning model, as described above.

Some implementations described herein enable a synthetic generation model to supplement an original dataset by generating a synthetic dataset. In particular, the synthetic generation model may keep at least one factor fixed during generation of the synthetic dataset in order to enable use of the synthetic dataset without inadvertently introducing an irrelevant feature during training, testing, and/or refinement of a machine learning model. As a result, the machine learning model is more accurate after training, testing, and/or refinement, which means that computer resources expended in training, testing, and/or refinement were used efficiently. Additionally, to improve security, the synthetic generation model may anonymize factors of the original dataset when generating the synthetic dataset. However, the synthetic generation model may refrain from anonymizing at least one factor during generation of the synthetic dataset in order to enable use of the synthetic dataset without inadvertently losing a relevant feature due to anonymization.

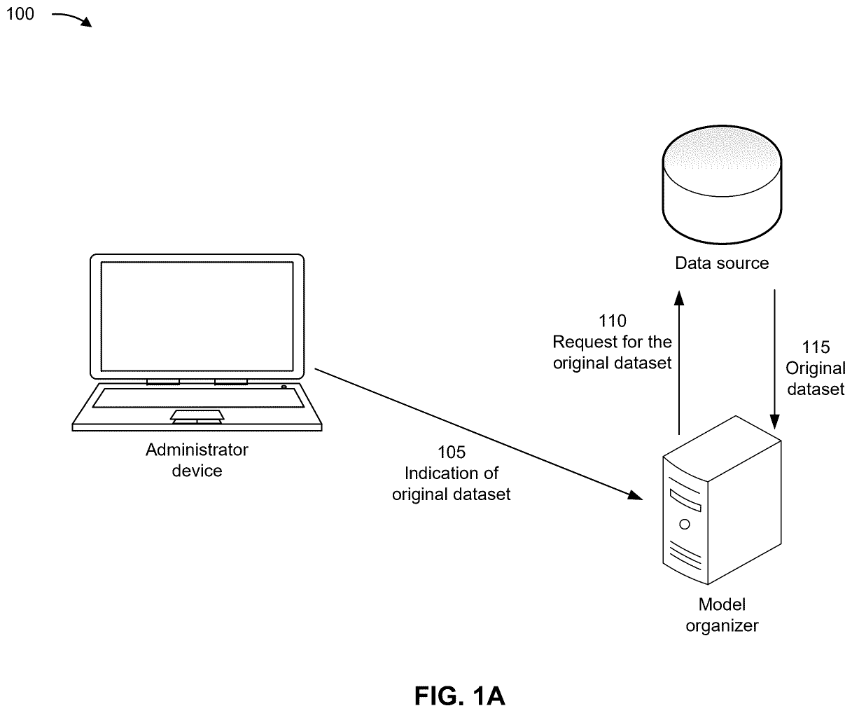

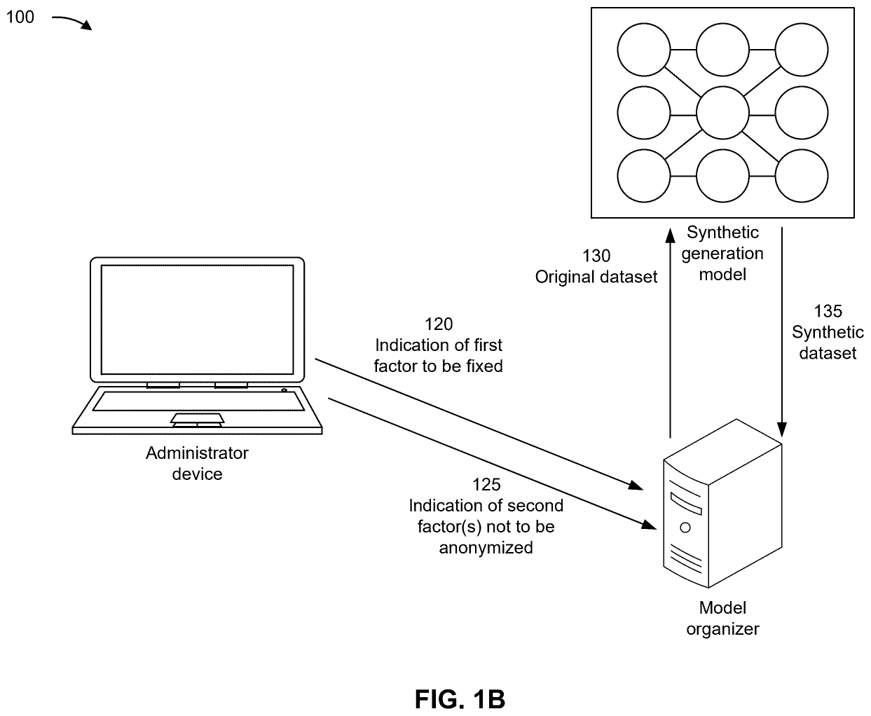

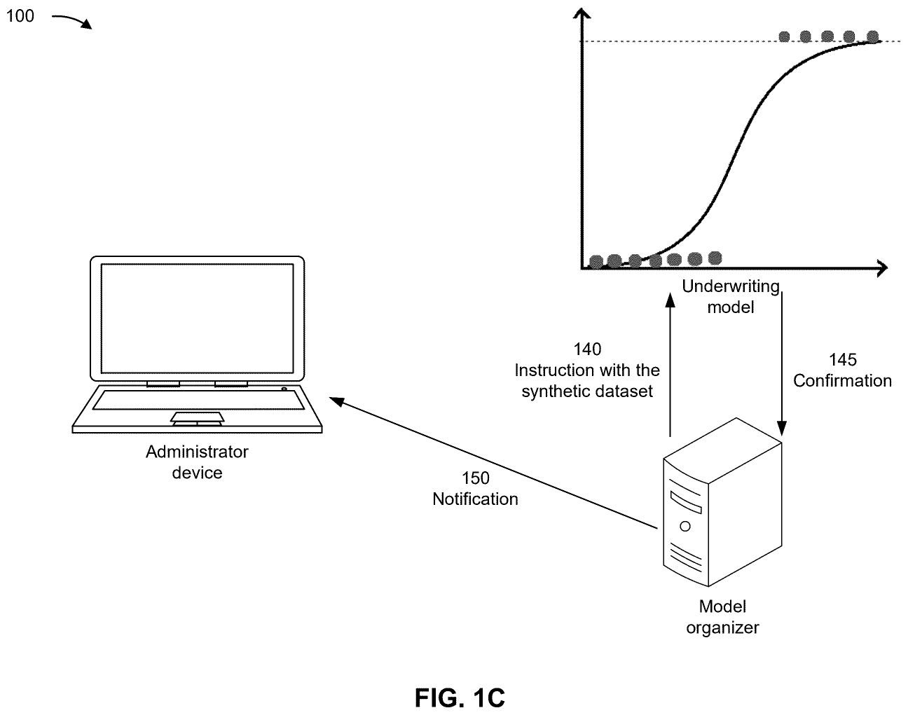

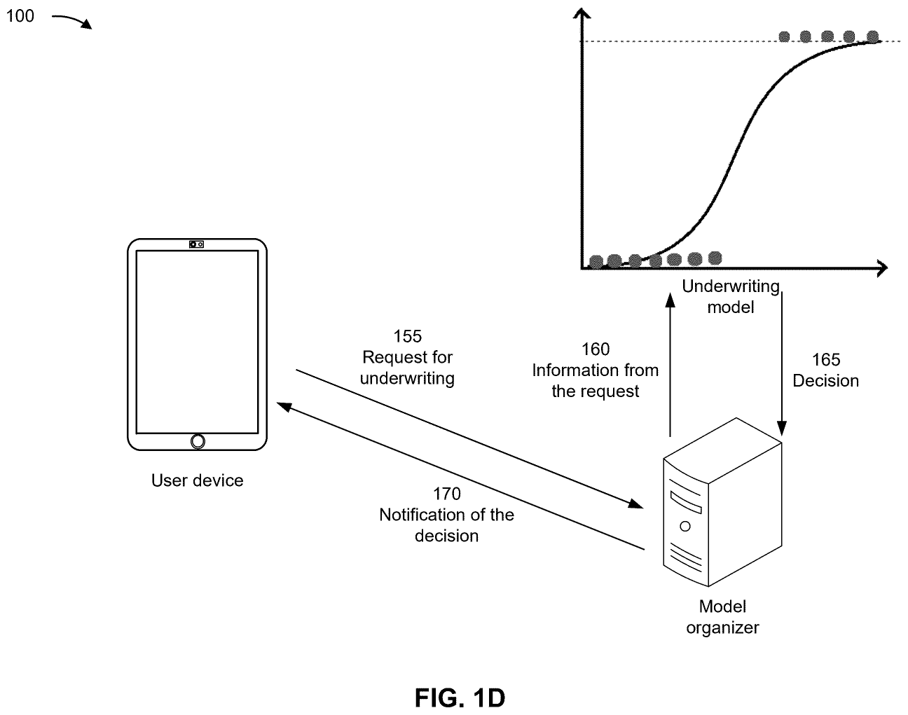

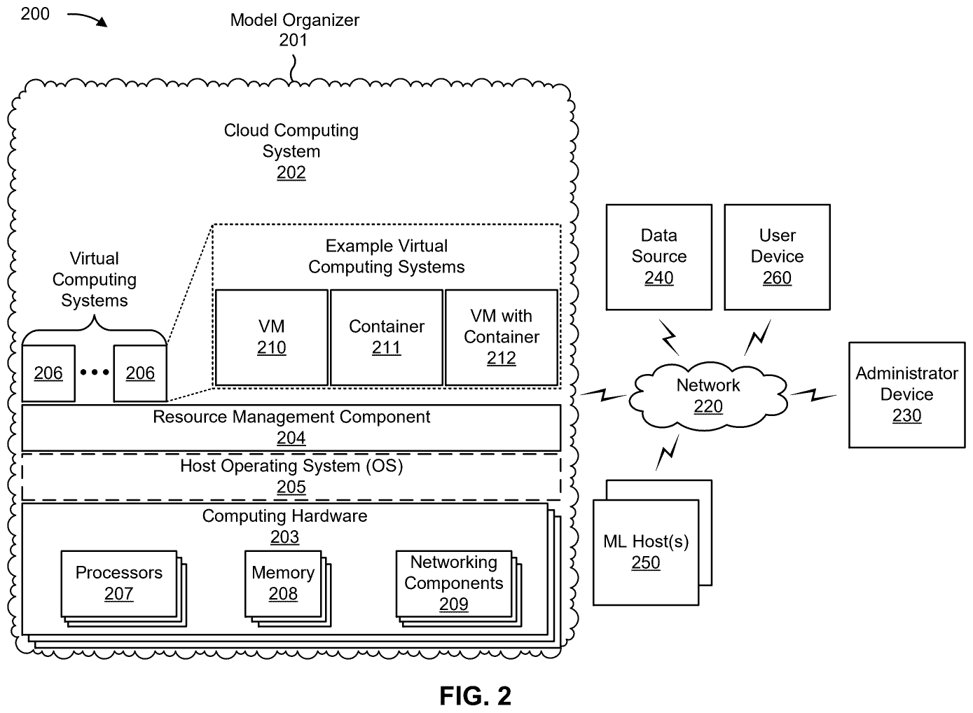

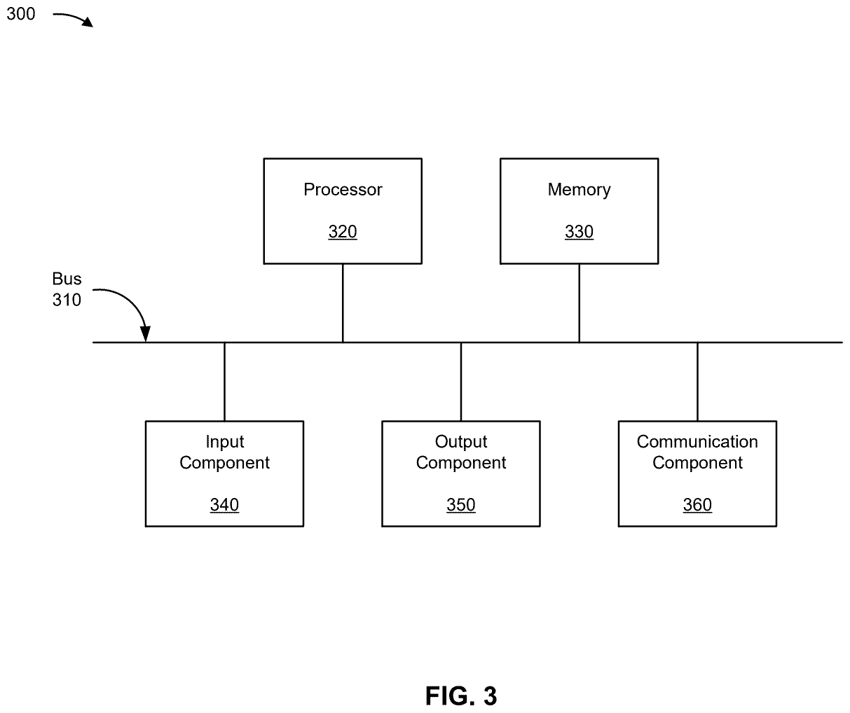

FIGS. 1A-1D are diagrams of an example 100 associated with using synthetic data to supplement small datasets. As shown in FIGS. 1A-1D, example 100 includes an administrator device, a model organizer, a data source, a synthetic generation model (e.g., provided by a first machine learning (ML) host), an underwriting model (e.g., provided by a second ML host), and a user device. These devices are described in more detail in connection with FIGS. 2 and 3.

As shown in FIG. 1A, the model organizer may receive an original dataset. In the example implementation 100, the model organizer receives the original dataset based on an indication from the administrator device. Other examples may include the model organizer receiving the original dataset directly from the administrator device or automatically requesting the original dataset (e.g., according to a schedule or in response to a trigger event).

As shown by reference number 105, the administrator device may transmit, and the model organizer may receive, an indication of the original dataset. The indication may include a string associated with the original dataset (e.g., a name or another type of alphanumeric identifier associated with the original dataset) or a location indicator associated with the original dataset. the location indicator may include a filename for the original dataset, a filepath for the original dataset, and/or an identifier of the data source (e.g., a machine name, an Internet protocol (IP) address, and/or a medium access control (MAC) address, among other examples) storing the original dataset. The original dataset may be small. As used herein, “small” may refer to a dataset with 20 or fewer entries (or entities) included in the dataset.

In addition to the indication of the original dataset, the administrator device may transmit, and the model organizer may receive, a set of credentials that permit access to the original dataset. For example, the set of credentials may permit access to the data source (or at least to the original dataset from the data source). The set of credentials may include a username and password, a passkey, a secret answer, a certificate, a token, a signature, and/or biometric information, among other examples. The set of credentials may be included in a same message as the indication of the original dataset (e.g., a request to generate synthetic data based on the original dataset). Alternatively, the set of credentials may be included in a separate message. For example, the model organizer may transmit (and the administrator device may receive) a prompt in response to the indication of the original dataset, and the administrator device may transmit (and the model organizer may receive) the set of credentials in response to the prompt. In another example, the model organizer may transmit (and the administrator device may receive) a prompt in response to the set of credentials, and the administrator device may transmit (and the model organizer may receive) the indication of the original dataset in response to the prompt.

In some implementations, an administrator using the administrator device may provide input that triggers the administrator device to transmit the indication of the original dataset. For example, the administrator device may output (e.g., via an output component of the administrator device) a user interface (UI). Therefore, the administrator may provide the input by interacting with the UI (e.g., via an input component of the administrator device). For example, the administrator device may detect an interaction with a text box (or another similar element) of the UI in order to receive the indication (e.g., because the administrator entered a name, a filename, a filepath, or another type of identifier associated with the original dataset). Additionally, the administrator device may detect an interaction with a button (or another similar element) of the UI in order to trigger transmission of the indication to the model organizer. In another example, the administrator may provide the input via a text interface, such as a command prompt or a shell. Alternatively, the administrator device may transmit the indication of the original dataset automatically (e.g., according to a schedule or in response to a trigger event).

As shown by reference number 110, the model organizer may transmit, and the data source may receive, a request for the original dataset. The model organizer may transmit, and the data source may receive, the request based on (e.g., in response to) the indication of the original dataset (from the administrator device). The request may include a hypertext transfer protocol (HTTP) request, a file transfer protocol (FTP) request, and/or an application programming interface (API) call, among other examples. The request may include (e.g., in a header and/or as an argument) an identifier associated with the original dataset. The identifier may be the indication of the original dataset (e.g., as received from the administrator device) or an identifier determined by the model organizer (e.g., by mapping the indication of the original dataset to the identifier).

As shown by reference number 115, the data source may transmit, and the model organizer may receive, the original dataset. The data source may transmit, and the model organizer may receive, the original dataset in response to the request (from the model organizer). The original dataset may be stored in a relational data structure (e.g., a tabular data structure using structured query language (SQL), among other examples) or another type of data structure (e.g., a NoSQL data structure). The original dataset may be encoded as a single file (e.g., a comma-separated values (CSV) file or another type of delimiter-separated values (DSV) file, among other examples) or as a plurality of files.

As shown in FIG. 1B and by reference number 120, the administrator device may transmit, and the model organizer may receive, an indication of a first factor to remain fixed. Therefore, the administrator device may indicate that the first factor, in the original dataset, should be held to a same value (or set of values) in the synthetic dataset. For example, the first factor may be associated with a geographic area (e.g., a country or a particular area of a country, such as a state, a city, or a region, among other examples) such that the synthetic dataset will be associated with the same geographic area as the original dataset. In another example, the first factor may be associated with an industry category (e.g., a class of goods or services, whether encoded using an index or a string) such that the synthetic dataset will be associated with the same industry category as the original dataset.

In some implementations, the administrator using the administrator device may provide input that triggers the administrator device to transmit the indication of the first factor. For example, the administrator device may output (e.g., via an output component of the administrator device) a UI. Therefore, the administrator may provide the input by interacting with the UI (e.g., via an input component of the administrator device). For example, the administrator device may detect an interaction with a checkbox, a set of radio buttons, or another similar element of the UI in order to receive the indication (e.g., because the administrator selected the first factor from a plurality of possible factors). Additionally, the administrator device may detect an interaction with a button (or another similar element) of the UI in order to trigger transmission of the indication to the model organizer. In another example, the administrator may provide the input via a text interface, such as a command prompt or a shell. Alternatively, the administrator device may transmit the indication of the first factor automatically (e.g., according to a default setting).

As shown in FIG. 1B and by reference number 125, the administrator device may transmit, and the model organizer may receive, an indication of at least one second factor to refrain from anonymizing. Therefore, the administrator device may indicate that the second factor(s), in the original dataset, should be varied in the synthetic dataset relative to an original value rather than an anonymized value. For example, the second factor(s) may include an address element (e.g., a zip code or another type of postal code, among other examples) such that the synthetic dataset will be associated with non-anonymized addressed elements (e.g., some address elements, if anonymized, may lose meaning). In another example, the second factor(s) may include a corporation type (e.g., a stock corporation, a partnership, or a limited liability company (LLC), among other examples) such that the synthetic dataset will be associated non-anonymized corporation types (e.g., corporation type may lose meaning if anonymized). In another example, the second factor(s) may include an entity structure (e.g., a subsidiary structure, a closely held corporate structure, or a publicly traded stock structure, among other examples) such that the synthetic dataset will be associated non-anonymized corporation types (e.g., some entity structures, if anonymized, may lose meaning).

In some implementations, the administrator using the administrator device may provide input that triggers the administrator device to transmit the indication of the second factor(s). For example, the administrator device may output (e.g., via an output component of the administrator device) a UI. Therefore, the administrator may provide the input by interacting with the UI (e.g., via an input component of the administrator device). For example, the administrator device may detect an interaction with a checkbox, a set of radio buttons, or another similar element of the UI in order to receive the indication (e.g., because the administrator selected the second factor(s) from a plurality of possible factors). Additionally, the administrator device may detect an interaction with a button (or another similar element) of the UI in order to trigger transmission of the indication to the model organizer. In another example, the administrator may provide the input via a text interface, such as a command prompt or a shell. Alternatively, the administrator device may transmit the indication of the second factor(s) automatically (e.g., according to a default setting).

As shown by reference number 130, the model organizer may provide the original dataset to the synthetic generation model. For example, the model organizer may transmit, and the first ML host associated with the synthetic generation model may receive, a request including the original dataset. The synthetic generation model may be trained (e.g., by the first ML host and/or a device at least partially separate from the first ML host) to vary (e.g., randomly, by introduction of Gaussian noise, or according to a variation pattern, among other examples) factors in entries (or entities) of the original dataset to generate entries (or entities) for a synthetic dataset. The synthetic generation model may refrain from varying the first factor. For example, the model organizer may indicate the first factor to the synthetic generation model (e.g., in the request to the first ML host).

In order to improve security, the synthetic generation model may additionally anonymize entries (or entities) of the original dataset. For example, names (of companies and/or people) may be replaced with nonce values. Similarly, some address elements (e.g., street numbers and names, among other examples) may be replaced. Therefore, the synthetic generation model may anonymize at least one third factor. On the other hand, synthetic generation model may refrain from anonymizing the second factor(s). For example, the model organizer may indicate the second factor(s) to the synthetic generation model (e.g., in the request to the first ML host). The synthetic generation model may still pseudonymize the second factor(s) (e.g., using a replacement set of values that can be mapped, or otherwise traced, to an original set of values in the original dataset). For example, the synthetic generation model may pseudonymize postal codes in the original dataset order to improve security but still convert pseudonymized postal codes in the synthetic dataset to actual postal codes before returning the synthetic dataset.

As shown by reference number 135, the synthetic generation model may output the synthetic dataset. For example, the model organizer may receive the synthetic dataset (e.g., from the first ML host in response to the request from the model organizer). Similar to the original dataset, the synthetic dataset may be stored in a relational data structure (e.g., a tabular data structure) or another type of data structure (e.g., a NoSQL data structure). The synthetic dataset may be encoded as a single file (e.g., a CSV file or another type of DSV file, among other examples) or as a plurality of files.

In some implementations, the model organizer may output a notification that the synthetic dataset has been generated by the synthetic generation model. For example, the model organizer may transmit, and the administrator device may receive, the notification. In some implementations, the notification may include instructions for a UI or a push alert (e.g., in response to the indication of the original dataset, the indication of the first factor, and/or the indication of the second factor(s) from the administrator device). Additionally, or alternatively, the notification may include an email message or a text message.

As shown in FIG. 1C and by reference number 140, the model organizer may provide the original dataset and the synthetic dataset to the underwriting model for training, testing, and/or refinement. For example, the model organizer may transmit, and the second ML host associated with the underwriting model may receive, a request including the original dataset and the synthetic dataset. In some implementations, the administrator device may transmit, and the model organizer may receive, an indication of the underwriting model. The indication may include a string associated with the underwriting model (e.g., a name or another type of alphanumeric identifier associated with the underwriting model) or a location indicator associated with the underwriting model. The location indicator may include an identifier of the second ML host (e.g., a machine name, an IP address, and/or a MAC address, among other examples) providing the underwriting model. In some implementations, the administrator using the administrator device may provide input that triggers the administrator device to transmit the indication of the underwriting model. For example, the administrator device may output (e.g., via an output component of the administrator device) a UI. Therefore, the administrator may provide the input by interacting with the UI (e.g., via an input component of the administrator device). For example, the administrator device may detect an interaction with a text box (or another similar element) of the UI in order to receive the indication (e.g., because the administrator entered a name or another type of identifier associated with the underwriting model). Additionally, the administrator device may detect an interaction with a button (or another similar element) of the UI in order to trigger transmission of the indication to the model organizer. In another example, the administrator may provide the input via a text interface, such as a command prompt or a shell. Alternatively, the administrator device may transmit the indication of the underwriting model automatically (e.g., based on a default setting).

The underwriting model may be trained (e.g., by the second ML host and/or a device at least partially separate from the second ML host) to determine whether to approve commercial lending for an entity. The underwriting model may determine an answer (e.g., a Boolean value or another type of binary value) and/or a score (e.g., that either satisfies an approval threshold or fails to satisfy the approval threshold). The ML model may be trained using the original dataset and the synthetic dataset.

In some implementations, the underwriting model may include a regression algorithm (e.g., linear regression or logistic regression), which may include a regularized regression algorithm (e.g., Lasso regression, Ridge regression, or Elastic-Net regression). Additionally, or alternatively, the underwriting model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., the original dataset and the synthetic dataset). For example, for a regression algorithm, a model parameter may include a regression coefficient (e.g., a weight). For a decision tree algorithm, a model parameter may include a decision tree split location, as an example. In a testing phase, accuracy of the underwriting model may be measured without modifying model parameters. In a refinement phase, the model parameters may be further modified from values determined in an original training phase.

Additionally, the second ML host (and/or a device at least partially separate from the second ML host) may use one or more hyperparameter sets to tune the underwriting model. A hyperparameter may include a structural parameter that controls execution of a machine learning algorithm by the second ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm. In a testing phase, accuracy of the underwriting model may be measured without modifying hyperparameters. In a refinement phase, the model parameters may be modified while the hyperparameters remain fixed.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

In some implementations, as shown by reference number 145, the underwriting model may output confirmation of training, testing, and/or refinement. For example, the model organizer may receive the confirmation (e.g., from the second ML host in response to the request from the model organizer).

In some implementations, the model organizer may output a notification that the underwriting model has been trained, tested, and/or refined. For example, as shown by reference number 150, the model organizer may transmit, and the administrator device may receive, the notification. In some implementations, the notification may include instructions for a UI or a push alert (e.g., in response to the indication of the original dataset, the indication of the first factor, and/or the indication of the second factor(s) from the administrator device). Additionally, or alternatively, the notification may include an email message or a text message.

The administrator device (e.g., based on input from the administrator) may make the underwriting model publicly available (or at least quasi-publicly available, such as by launching a beta test phase). Therefore, a user of the user device may receive a decision based on the underwriting model, as shown in FIG. 1D. As shown by reference number 155, the user device may transmit, and the model organizer may receive, a request for underwriting. The request may include information associated with an entity seeking commercial lending. The information associated with the entity may include a name of the entity, an address associated with the entity, formation documents for the entity, financial information associated with the entity (e.g., profits, revenues, tax liabilities, and so on), and/or financial statements from the entity, among other examples. The request may additionally include information associated with the commercial lending. For example, the information associated with the commercial lending may include a loan amount that is requested, a desired interest rate, a loan term that is proposed, and/or an indication of how the loan may be used (e.g., equipment purchase, expansion, working capital, and so on), among other examples.

In some implementations, a user using the user device may provide input that triggers the user device to transmit the request for underwriting. For example, the user device may output (e.g., via an output component of the administrator device) a UI. Therefore, the user may provide the input by interacting with the UI (e.g., via an input component of the user device). In some implementations, a web browser (or another similar type of application) executed by the user device may navigate to a webpage hosted by (or at least associated with) the model organizer. Accordingly, the web browser may output the webpage (e.g., in a UI), and the user may provide the input by interacting with the webpage. In another example, the user may provide the input via a text interface, such as a command prompt or a shell. Alternatively, the user device may transmit the request for underwriting (e.g., according to a schedule or in response to a trigger event).

As shown by reference number 160, the model organizer may provide information from the request for underwriting to the underwriting model. For example, the model organizer may transmit, and the second ML host associated with the underwriting model may receive, a request including the information. In some implementations, the model organizer may receive additional public information, associated with the entity, from third-party data sources and may provide the additional public information to the underwriting model. For example, the model organizer may transmit a request for (and thus receive) profiles for a management team of the entity, a credit worthiness indicator for the entity (e.g., a business credit report), and/or adverse information associated with the entity (e.g., bankruptcies, defaults, litigations, and so on), among other examples.

As shown by reference number 165, the underwriting model may output a decision. For example, the model organizer may receive the decision (e.g., from the second ML host in response to the request from the model organizer). Because the underwriting model was trained, tested, and/or refined using the synthetic dataset, the underwriting model may factor, into the decision, an industry landscape from the synthetic dataset and/or historic or predicted performance for similar entities in the synthetic dataset. As described above, the decision may include an answer (e.g., a Boolean value or another type of binary value) and/or a score (e.g., that either satisfies an approval threshold or fails to satisfy the approval threshold). Additionally, or alternatively, the decision may include proposed commercial lending terms. For example, the underwriting model may suggest a different loan amount than requested, a different guarantee structure than offered, a different interest rate than desired, and/or a different loan term than proposed, among other examples.

In some implementations, the model organizer may output a notification of the decision. For example, as shown by reference number 170, the model organizer may transmit, and the user device may receive, the notification. In some implementations, the notification may include instructions for a UI or a push alert (e.g., in response to the request for underwriting). Additionally, or alternatively, the notification may include an email message or a text message.

By using techniques as described in connection with FIGS. 1A-1D, the synthetic generation model refrains from varying the first factor during generation of the synthetic dataset in order to enable use of the synthetic dataset without inadvertently introducing an irrelevant feature during training, testing, and/or refinement of the underwriting model. As a result, the underwriting model is more accurate after training, testing, and/or refinement, which means that computer resources expended in training, testing, and/or refinement were used efficiently. Additionally, to improve security, the synthetic generation model may anonymize the third factor(s) when generating the synthetic dataset, but may refrain from anonymizing the second factor(s) during generation of the synthetic dataset, in order to enable use of the synthetic dataset without inadvertently losing a relevant feature due to anonymization.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a model organizer 201, which may include one or more elements of and/or may execute within a cloud computing system 202. The cloud computing system 202 may include one or more elements 203-212, as described in more detail below. As further shown in FIG. 2, environment 200 may include a network 220, an administrator device 230, a data source 240, one or more ML hosts 250, and/or a user device 260. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the model organizer 201 may include one or more elements 203-212 of the cloud computing system 202, may execute within the cloud computing system 202, and/or may be hosted within the cloud computing system 202, in some implementations, the model organizer 201 may not be cloud-based (e.g., may be implemented outside of a cloud computing system) or may be partially cloud-based. For example, the model organizer 201 may include one or more devices that are not part of the cloud computing system 202, such as device 300 of FIG. 3, which may include a standalone server or another type of computing device. The model organizer 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The administrator device 230 may include one or more devices capable of receiving, generating, storing, processing, and/or providing information associated with datasets, as described elsewhere herein. The administrator device 230 may include a communication device and/or a computing device. For example, the administrator device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 230 may communicate with one or more other devices of environment 200, as described elsewhere herein.

The data source 240 may include one or more devices capable of receiving, generating, storing, processing, and/or providing information associated with datasets, as described elsewhere herein. The data source 240 may include a communication device and/or a computing device. For example, the data source 240 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 240 may communicate with one or more other devices of environment 200, as described elsewhere herein.

The ML host(s) 250 may include one or more devices capable of receiving, generating, storing, processing, and/or providing information associated with machine learning models (e.g., a synthetic generation model and/or an underwriting model), as described elsewhere herein. The ML host(s) 250 may include a communication device and/or a computing device. For example, the ML host(s) 250 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host(s) 250 may communicate with one or more other devices of environment 200, as described elsewhere herein.

The user device 260 may include one or more devices capable of receiving, generating, storing, processing, and/or providing information associated with requests for underwriting, as described elsewhere herein. The user device 260 may include a communication device and/or a computing device. For example, the user device 260 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 260 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with using synthetic data to supplement small datasets. The device 300 may correspond to an administrator device 230, a data source 240, an ML host 250, and/or a user device 260. In some implementations, an administrator device 230, a data source 240, an ML host 250, and/or a user device 260 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

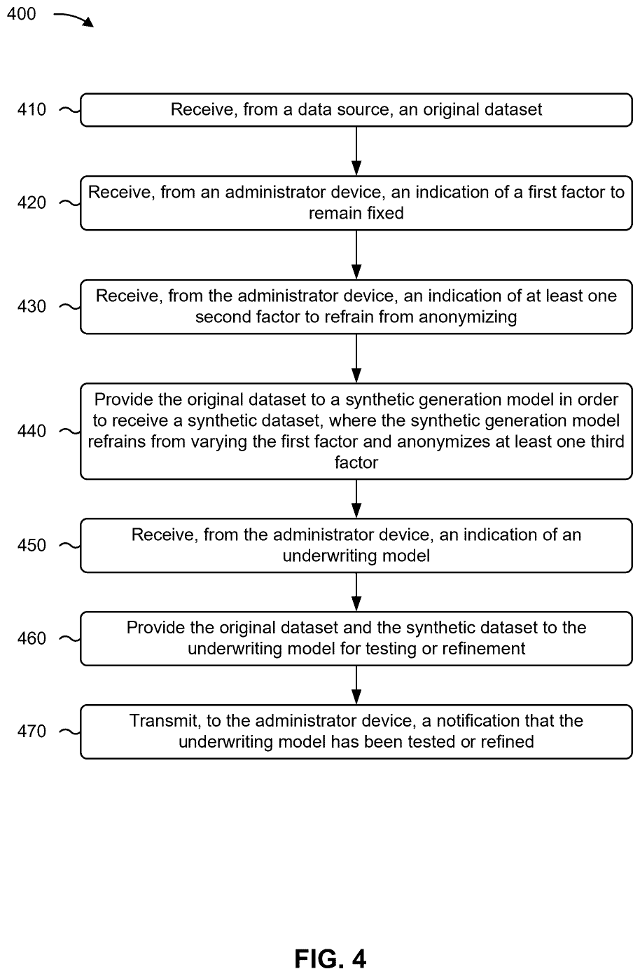

FIG. 4 is a flowchart of an example process 400 associated with using synthetic data to supplement small datasets. In some implementations, one or more process blocks of FIG. 4 may be performed by a model organizer 201. In some implementations, one or more process blocks of FIG. 4 may be performed by another device or a group of devices separate from or including the model organizer 201, such as an administrator device 230, a data source 240, an ML host 250, and/or a user device 260. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, from a data source, the original dataset (block 410). For example, the model organizer 201 (e.g., using processor 320, memory 330, and/or communication component 360) may receive, from a data source, the original dataset, as described above in connection with reference number 115 of FIG. 1A. As an example, the model organizer 201 may transmit, to the data source, a request for the original dataset (e.g., an HTTP request, an FTP request, and/or an API call, among other examples). Therefore, the model organizer 201 may receive, from the data source, the original dataset in response to the request.

As further shown in FIG. 4, process 400 may include receiving, from an administrator device, an indication of a first factor to remain fixed (block 420). For example, the model organizer 201 (e.g., using processor 320, memory 330, and/or communication component 360) may receive, from an administrator device, an indication of a first factor to remain fixed, as described above in connection with reference number 120 of FIG. 1B. As an example, the first factor, in the original dataset, may be held to a same value (or set of values) in a synthetic dataset to be generated. The first factor may be associated with a geographic area (e.g., a country or a particular area of a country, such as a state, a city, or a region, among other examples) and/or an industry category (e.g., a class of goods or services, whether encoded using an index or a string), among other examples.

As further shown in FIG. 4, process 400 may include receiving, from the administrator device, an indication of at least one second factor to refrain from anonymizing (block 430). For example, the model organizer 201 (e.g., using processor 320, memory 330, and/or communication component 360) may receive, from the administrator device, an indication of at least one second factor to refrain from anonymizing, as described above in connection with reference number 125 of FIG. 1B. As an example, the at least one second factor, in the original dataset, may be varied, for generation a synthetic dataset, relative to an original value rather than an anonymized value. For example, the at least one second factor may include an address element (e.g., a zip code or another type of postal code, among other examples), a corporation type (e.g., a stock corporation, a partnership, or an LLC, among other examples), and/or an entity structure (e.g., a subsidiary structure, a closely held corporate structure, or a publicly traded stock structure, among other examples).

As further shown in FIG. 4, process 400 may include providing the original dataset to a synthetic generation model in order to receive the synthetic dataset, where the synthetic generation model refrains from varying the first factor and anonymizes at least one third factor (block 440). For example, the model organizer 201 (e.g., using processor 320, memory 330, and/or communication component 360) may provide the original dataset to a synthetic generation model in order to receive the synthetic dataset, where the synthetic generation model refrains from varying the first factor and anonymizes at least one third factor, as described above in connection with FIG. 1B. As an example, the synthetic generation model may be trained to vary (e.g., randomly, by introduction of Gaussian noise, or according to a variation pattern, among other examples) factors in entries (or entities) of the original dataset to generate entries (or entities) for the synthetic dataset. The synthetic generation model may refrain from varying the first factor. In order to improve security, the synthetic generation model may anonymize the at least one third factor. On the other hand, synthetic generation model may refrain from anonymizing the at least one second factor. The synthetic generation model may still pseudonymize the at least one second factor (e.g., using a replacement set of values that can be mapped, or otherwise traced, to an original set of values in the original dataset).

As further shown in FIG. 4, process 400 may include receiving, from the administrator device, an indication of an underwriting model (block 450). For example, the model organizer 201 (e.g., using processor 320, memory 330, and/or communication component 360) may receive, from the administrator device, an indication of an underwriting model, as described above in connection with FIG. 1C. As an example, the indication of the underwriting model may be received in a same message as the indication of the original dataset or in a separate message.

As further shown in FIG. 4, process 400 may include providing the original dataset and the synthetic dataset to the underwriting model for testing or refinement (block 460). For example, the model organizer 201 (e.g., using processor 320, memory 330, and/or communication component 360) may provide the original dataset and the synthetic dataset to the underwriting model for testing or refinement, as described above in connection with FIG. 1C. As an example, testing may include measuring accuracy of the underwriting model without modifying model parameters; refinement may include modifying model parameters of the underwriting model without modifying hyperparameters of the underwriting model.

As further shown in FIG. 4, process 400 may include transmitting, to the administrator device, a notification that the underwriting model has been tested or refined (block 470). For example, the model organizer 201 (e.g., using processor 320, memory 330, and/or communication component 360) may transmit, to the administrator device, a notification that the underwriting model has been tested or refined, as described above in connection with reference number 150 of FIG. 1C. As an example, the notification may include instructions for a UI or a push alert (e.g., in response to the indication of the original dataset, the indication of the first factor, and/or the indication of the at least one second factor from the administrator device). Additionally, or alternatively, the notification may include an email message or a text message.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

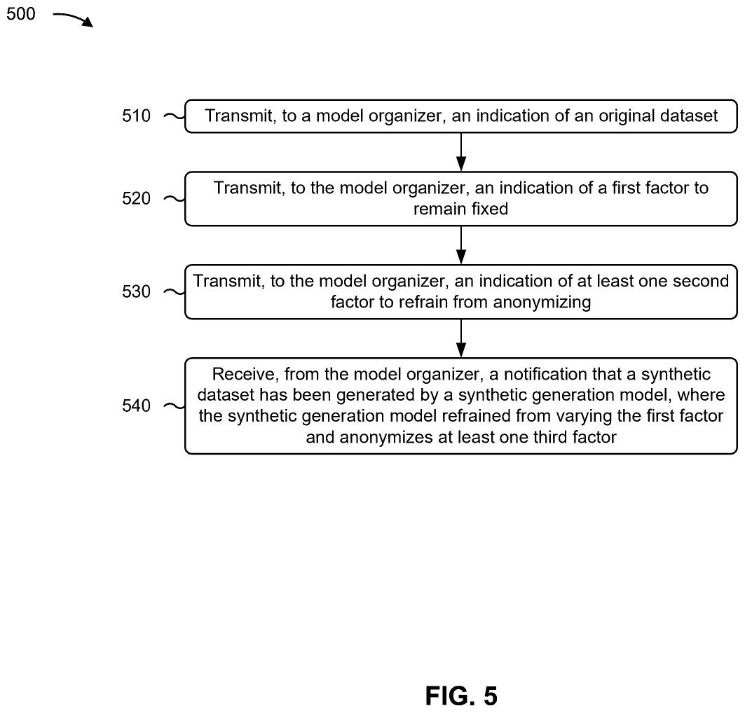

FIG. 5 is a flowchart of an example process 500 associated with using synthetic data to supplement small datasets. In some implementations, one or more process blocks of FIG. 5 may be performed by an administrator device 230. In some implementations, one or more process blocks of FIG. 5 may be performed by another device or a group of devices separate from or including the administrator device 230, such as an administrator device 230, a data source 240, an ML host 250, and/or a user device 260. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include transmitting, to a model organizer, an indication of the original dataset (block 510). For example, the administrator device 230 (e.g., using processor 320, memory 330, and/or communication component 360) may transmit, to a model organizer, an indication of the original dataset, as described above in connection with reference number 105 of FIG. 1A. As an example, an administrator using the administrator device 230 may provide input that triggers the administrator device 230 to transmit the indication of the original dataset. For example, the administrator device may output (e.g., via output component 350) a UI. Therefore, the administrator may provide the input by interacting with the UI (e.g., via input component 340). In another example, the administrator may provide the input via a text interface, such as a command prompt or a shell. Alternatively, the administrator device 230 may transmit the indication of the original dataset automatically (e.g., according to a schedule or in response to a trigger event).

As further shown in FIG. 5, process 500 may include transmitting, to the model organizer, an indication of a first factor to remain fixed (block 520). For example, the administrator device 230 (e.g., using processor 320, memory 330, and/or communication component 360) may transmit, to the model organizer, an indication of a first factor to remain fixed, as described above in connection with reference number 120 of FIG. 1B. As an example, an administrator using the administrator device 230 may provide input that triggers the administrator device 230 to transmit the indication of the first factor. For example, the administrator device 230 may output (e.g., via output component 350) a UI. Therefore, the administrator may provide the input by interacting with the UI (e.g., via input component 340). In another example, the administrator may provide the input via a text interface, such as a command prompt or a shell. Alternatively, the administrator device 230 may transmit the indication of the first factor automatically (e.g., according to a default setting).

As further shown in FIG. 5, process 500 may include transmitting, to the model organizer, an indication of at least one second factor to refrain from anonymizing (block 530). For example, the administrator device 230 (e.g., using processor 320, memory 330, and/or communication component 360) may transmit, to the model organizer, an indication of at least one second factor to refrain from anonymizing, as described above in connection with reference number 125 of FIG. 1B. As an example, an administrator using the administrator device 230 may provide input that triggers the administrator device to transmit the indication of the at least one second factor. For example, the administrator device 230 may output (e.g., via output component 350) a UI. Therefore, the administrator may provide the input by interacting with the UI (e.g., via input component 340). In another example, the administrator may provide the input via a text interface, such as a command prompt or a shell. Alternatively, the administrator device 230 may transmit the indication of the at least one second factor automatically (e.g., according to a default setting).

As further shown in FIG. 5, process 500 may include receiving, from the model organizer, a notification that the synthetic dataset has been generated by a synthetic generation model, where the synthetic generation model refrained from varying the first factor and anonymizes at least one third factor (block 540). For example, the administrator device 230 (e.g., using processor 320, memory 330, and/or communication component 360) may receive, from the model organizer, a notification that the synthetic dataset has been generated by a synthetic generation model, where the synthetic generation model refrained from varying the first factor and anonymizes at least one third factor, as described above in connection with FIG. 1B. As an example, the notification may include instructions for a UI or a push alert (e.g., in response to the indication of the original dataset, the indication of the first factor, and/or the indication of the at least one second factor from the administrator device 230). Additionally, or alternatively, the notification may include an email message or a text message.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating a synthetic dataset to supplement an original dataset, the system comprising:
one or more memories; and
one or more processors, communicatively coupled to the one or more memories, configured to:
receive, from a data source, the original dataset;
receive, from an administrator device, an indication of a first factor to remain fixed;
receive, from the administrator device, an indication of at least one second factor to refrain from anonymizing;
provide the original dataset to a synthetic generation model in order to receive the synthetic dataset, wherein the synthetic generation model refrains from varying the first factor and anonymizes at least one third factor;
receive, from the administrator device, an indication of an underwriting model;
provide the original dataset and the synthetic dataset to the underwriting model for training; and
transmit, to the administrator device, a notification that the underwriting model has been trained.

2. The system of claim 1, wherein the one or more processors are configured to:
receive, from the administrator device, an indication of the original dataset; and
transmit, to the data source, a request for the original dataset based on the indication of the original dataset,
wherein the original dataset is received in response to the request.

3. The system of claim 1, wherein the first factor is associated with a geographic area or an industry category.

4. The system of claim 1, wherein the at least one second factor includes an address element, a corporation type, or an entity structure.

5. The system of claim 1, wherein the one or more processors, to provide the original dataset to the synthetic generation model in order to receive the synthetic dataset, are configured to:
transmit, to a machine learning host associated with the synthetic generation model, a request including the original dataset; and
receive, from the machine learning host, the synthetic dataset in response to the request.

6. The system of claim 1, wherein the notification comprises an email message or a text message.

7. The system of claim 1, wherein the original dataset comprises a small dataset.

8. A method of generating a synthetic dataset to supplement an original dataset, comprising:
receiving, at a model organizer and from a data source, the original dataset;
receiving, at the model organizer and from an administrator device, an indication of a first factor to remain fixed;
receiving, at the model organizer and from the administrator device, an indication of at least one second factor to refrain from anonymizing;
providing the original dataset to a synthetic generation model in order to receive the synthetic dataset, wherein the synthetic generation model refrains from varying the first factor and anonymizes at least one third factor;
receiving, at the model organizer and from the administrator device, an indication of an underwriting model;
providing the original dataset and the synthetic dataset to the underwriting model for testing or refinement; and
transmitting, from the model organizer and to the administrator device, a notification that the underwriting model has been tested or refined.

9. The method of claim 8, further comprising:
receiving, at the model organizer and from the administrator device, an indication of the original dataset,
wherein the indication of the original dataset comprises a filepath associated with the original dataset.

10. The method of claim 8, wherein the first factor is associated with a geographic area or an industry category.

11. The method of claim 8, wherein the at least one second factor includes an address element, a corporation type, or an entity structure.

12. The method of claim 8, wherein providing the original dataset and the synthetic dataset to the underwriting model comprises:
transmitting, to a machine learning host associated with the underwriting model, a request including the original dataset and the synthetic dataset.

13. The method of claim 8, wherein the notification comprises instructions for a user interface or a push alert.

14. The method of claim 8, wherein the original dataset comprises a small dataset.

15. A non-transitory computer-readable medium storing a set of instructions for requesting a synthetic dataset to supplement an original dataset, the set of instructions comprising:
one or more instructions that, when executed by one or more processors of a device, cause the device to:
transmit, to a model organizer, an indication of the original dataset;
transmit, to the model organizer, an indication of a first factor to remain fixed;
transmit, to the model organizer, an indication of at least one second factor to refrain from anonymizing; and
receive, from the model organizer, a notification that the synthetic dataset has been generated by a synthetic generation model, wherein the synthetic generation model refrains from varying the first factor and anonymizes at least one third factor.

16. The non-transitory computer-readable medium of claim 15, wherein the one or more instructions, when executed by the one or more processors, cause the device to:
transmit, to the model organizer, an indication of an underwriting model; and
receive, from the model organizer, a notification that the underwriting model was trained using the synthetic dataset.

17. The non-transitory computer-readable medium of claim 15, wherein the one or more instructions, when executed by the one or more processors, cause the device to:
transmit, to the model organizer, an indication of an underwriting model; and
receive, from the model organizer, a notification that the underwriting model was tested or refined using the synthetic dataset.

18. The non-transitory computer-readable medium of claim 15, wherein the one or more instructions, that cause the device to transmit the indication of the original dataset, cause the device to:
transmit an indication of a location of the original dataset; and
transmit a set of credentials that permit access to the original dataset.

19. The non-transitory computer-readable medium of claim 15, wherein the one or more instructions, that cause the device to transmit the indication of the first factor, cause the device to:
output a user interface (UI);
detect an interaction with the UI; and
transmit the indication of the first factor based on the interaction.

20. The non-transitory computer-readable medium of claim 15, wherein the one or more instructions, that cause the device to transmit the indication of the at least one second factor, cause the device to:
output a user interface (UI);
detect an interaction with the UI; and
transmit the indication of the at least one second factor based on the interaction.
